(19) United States
(12) Patent Application Publication
(10) Pub. No.: US 2007/0056527 A1
(43) Pub. Date: Mar. 15, 2007

(54) Pet ball

(76) Inventors: John Sparks, Hamilton, OH (US); Henrietta Sparks, Hamilton, OH (US)

Correspondence Address: GREENBLUM & BERNSTEIN, P.L.C., 1950 ROLAND CLARKE PLACE, RESTON, VA, 20191, US

(21) Appl. No.: 11/224,025

(22) Filed: Sep. 13, 2005

(51) Int. Cl. A01K 27/00

(52) U.S. Cl. 119/796

(57) ABSTRACT

A pet restraining device including a housing, a leash mechanism provided in the housing, ballast provided in the bottom portion of the housing such that the pet restraining device has a center of gravity that is nearer to the bottom portion of the housing than to the top portion of the housing, and filling material provided in the housing to fill the spaces and secure elements of the device together. A method of making a pet restraining device including providing a housing, providing a leash mechanism in the housing, providing ballast in the bottom portion of the housing to produce a low center of gravity of the housing, and providing filling material in the housing to fill the spaces and secure elements of the device together.

### BACKGROUND OF THE INVENTION

1. Field of the Invention

The present invention relates to the field of pet restraints, and in particular, to a portable pet anchoring device including a retractable leash to maintain a pet in a desired location.

2. Description of the Related Art

There are different types of animal restraint systems known in the art. For example, the prior art includes a hitching weight disclosed by U.S. Pat. No. 843,543 to MATSUMOTO. The MATSUMOTO patent discloses a hitching weight including a chain and springs attached to a hemispherical shaped weighted member. The chain may be attached to an animal, such as a horse, via the ring. The weighted member prevents the animal from traveling too far and holds the animal in a desired general location. Additional weighted animal restraint systems are disclosed in U.S. Pat. No. 6,536,376 to BROWN and U.S. Pat. No. 6,578,528 to BROWN. The BROWN patents disclose a pet anchoring device including a base and a restraining cord connector. A pet may be tethered to the weighted base via a leash connected to the restraining cord connector. Additionally, the weight of the base may be adjusted to accommodate the size of the pet and/or the size of the area in which the pet is confined. Further, U.S. Pat. No. 5,456,214 to QUILLING and U.S. Pat. No. 6,745,722 to QUILLING disclose a pet tethering device including a link projecting from a weighted member. The link may be attached to a leash; and the weighted member anchors the pet.

Also known in the animal restraint system art are leashes. U.S. Pat. No. 6,845,737 to AUSTIN discloses a combination dog leash and ball in which the leash is contained inside the ball. To operate to restrain a pet, the leash is pulled from the ball. To operate the device as a pet toy, the leash is retracted inside the ball. Another type of leash is disclosed in U.S. Pat. No. 6,619,239 to BENSON et al. BENSON et al. discloses a retractable dog leash including a weighted portion for use by the user as a dumbbell for exercise. U.S. Patent Publication No. 2004/0237906 to WAXMAN et al. discloses a retractable leash including a housing, a handle, and a leash wound around an internal reel.

### SUMMARY OF THE INVENTION

The present invention is directed to a pet anchoring device, which addresses the problems existing in the prior art, discussed above.

An aspect of the present invention provides a pet restraining device including a housing having a top portion, a bottom portion, and a cavity therein; a retractable leash mechanism provided in the housing cavity; and ballast provided in the housing cavity, the ballast being positioned in the bottom portion of the housing such that the pet restraining device has a center of gravity that is nearer to the bottom portion of the housing than to the top portion of the housing. A further aspect of the present invention includes filling material provided in the cavity, the filling material securing the retractable leash mechanism and the ballast inside the cavity. The pet restraining device may further include an aperture provided in the top portion of the housing; a leash provided in the retractable leash mechanism; and a guide tube provided in the aperture, the guide tube being configured to receive the leash therein such that the leash extends and retracts through the guide tube to project from the housing. Further, the pet restraining device may further include an aperture provided in the top portion of the housing; and a handle provided on the retractable leash mechanism, the aperture being configured to receive the handle therein such that the handle projects from the housing.

A further aspect of the present invention provides a pet restraining device including a housing having a dome shaped top portion and a flat bottom portion; a leash mechanism provided in the housing; and ballast provided in the housing, the ballast being positioned near the flat bottom portion of the housing such that the pet restraining device has a low center of gravity. Further, the ballast may include one of sand, iron ore, and water. The housing may include filling material provided in the housing, the filling material securing the retractable leash mechanism and the ballast inside the housing; and the filling material may include expandable foam. In a further aspect of the present invention, the housing is constructed of foam material; and the flat bottom portion includes a base of the housing, further including tape provided on the base of the housing. Additionally, the pet restraining device may include an aperture provided in the dome shaped top portion of the housing; a leash provided in the leash mechanism; and a guide tube provided in the aperture, the guide tube being configured to receive the leash therein such that the leash extends and retracts through the guide tube to project from the housing. Further, the pet restraining device may include an aperture provided in the dome shaped top portion of the housing; and a handle provided on the leash mechanism, the aperture being configured to receive the handle therein such that the handle projects from the housing.

A further aspect of the present invention includes a method of making a pet restraining device including providing a housing having a top portion and a bottom portion; forming a cavity in the housing; providing a leash mechanism in the housing cavity; and providing ballast in the housing cavity, the ballast being positioned in the bottom portion of the housing such that the pet restraining device has a center of gravity that is nearer to the bottom portion of the housing than to the top portion of the housing. The method may further include providing filling material in the cavity, the filling material securing the leash mechanism and the ballast inside the cavity; and providing an aperture in the top portion of the housing; providing a leash in the leash mechanism; and providing a guide tube in the aperture, the guide tube being configured to receive the leash therein such that the leash extends and retracts through the guide tube to project from the housing. In further aspect of the invention, providing a housing includes providing a solid body ball; removing a portion of the ball, to provide a dome shaped top portion and a flat bottom portion; and providing a cavity in the housing including removing an interior portion of the solid body ball. Further, filling may include filling the cavity with expandable foam. Additionally, the flat bottom portion includes a base of the housing, further including providing tape on the base of the housing.

### BRIEF DESCRIPTION OF THE DRAWINGS

The above, and other objects, features and advantages of the present invention will be made apparent from the following description of the preferred embodiments, given as nonlimiting examples, with reference to the accompanying drawings in which:

FIG. 1 is a perspective view of the pet ball of an embodiment of the present invention in use and attached to a pet;

FIG. 2 is a front elevational view of the pet ball of FIG. 1, showing the leash in a retracted position;

FIG. 3 is a front elevational view of the pet ball of FIG. 1, showing the leash in an extended position;

FIG. 4 is a right side elevational view of the pet ball of FIG. 1; and

FIG. 5 is a cross sectional view of the pet ball of FIG. 1, taken along line A-A in FIG. 4.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

The present invention is directed to a pet restraint device. Objects of the invention include providing a pet anchoring device that is self-contained, portable, and stable, that rights itself, is reactive and tangle free, that protects pets, and that rotates 360 degrees continually. With the pet restraint system 1 of the present invention, one can relax on the patio, deck, or porch, or spend time in the park, while one's pet is secured safely nearby. Further, the pet restraint system 1 of the present invention may be used while traveling, camping, or doing yard chores. The pet restraint system 1 of the present invention may also be used while loading and unloading vehicles such as cars, trucks, recreational vehicles, or boats.

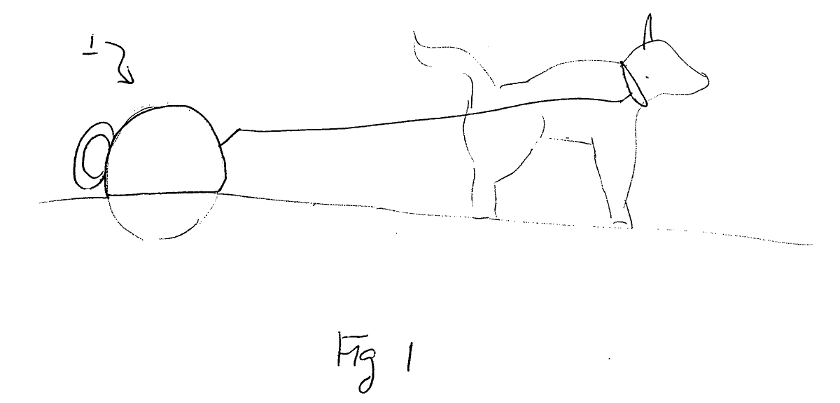

With reference to FIGS. 1-5 of the drawings, reference numeral 1 denotes the pet restraint device of the present invention. The pet restraint device 1 includes a body 2. The body 2 is substantially dome shaped with an upper portion 3 and a lower portion 4. As shown in the figures, the upper portion 3 has a curved shape and the lower portion 4 has a flat shape. The pet restraint system 1 also includes a handle 5 provided on the body 2. The handle 5 extends from the upper portion 3 of the body 2, and may extend through an aperture 9 in the upper portion 3 of the body 2. The pet restraint system 1 further includes a retractable leash 6 having a ring 7 provided on an end thereof. The retractable leash 6 extends through a guide tube 8 in the upper portion 3 of the body 2. The ring 7 is configured to be attached to a pet, such as by a collar. The retractable leash 6 extends and retracts to allow a pet to move toward and away from the body 2. Additionally, the retractable leash 6 allows the leash to be stored inside the body 2 of the pet restraint system 1. The flat bottom and low center of gravity allows the body 2 to right itself. Additionally, the flat bottom prevents the body 2 from rolling across the ground surface when pulled on by a pet.

In use, and as shown in FIG. 1, the pet restraint system 1 may be attached to a pet collar via the leash 6. The pet restraint system 1 will be positioned on the ground surface with a pet attached thereto, to hold the pet and to prevent the pet from moving out of a certain area. The pet will be able to move toward and away from the restraint system 1. The leash 6 will extend when the pet moves away from the body 2, and the leash 6 will retract when the pet moves closer to the body 2. Additionally, the pet will also be able to move around the restraint system 1 generally in a circle with the restraint system being the center of the circle. In this regard, when the pet moves in a circular motion, the leash may move about while the body 2 stays stationary on the ground surface. Alternatively, the pet may move about in a circular motion such that the body 2 revolves around itself. In either case, the leash 6 of the pet restraint system 1 of the present invention will not become entangled.

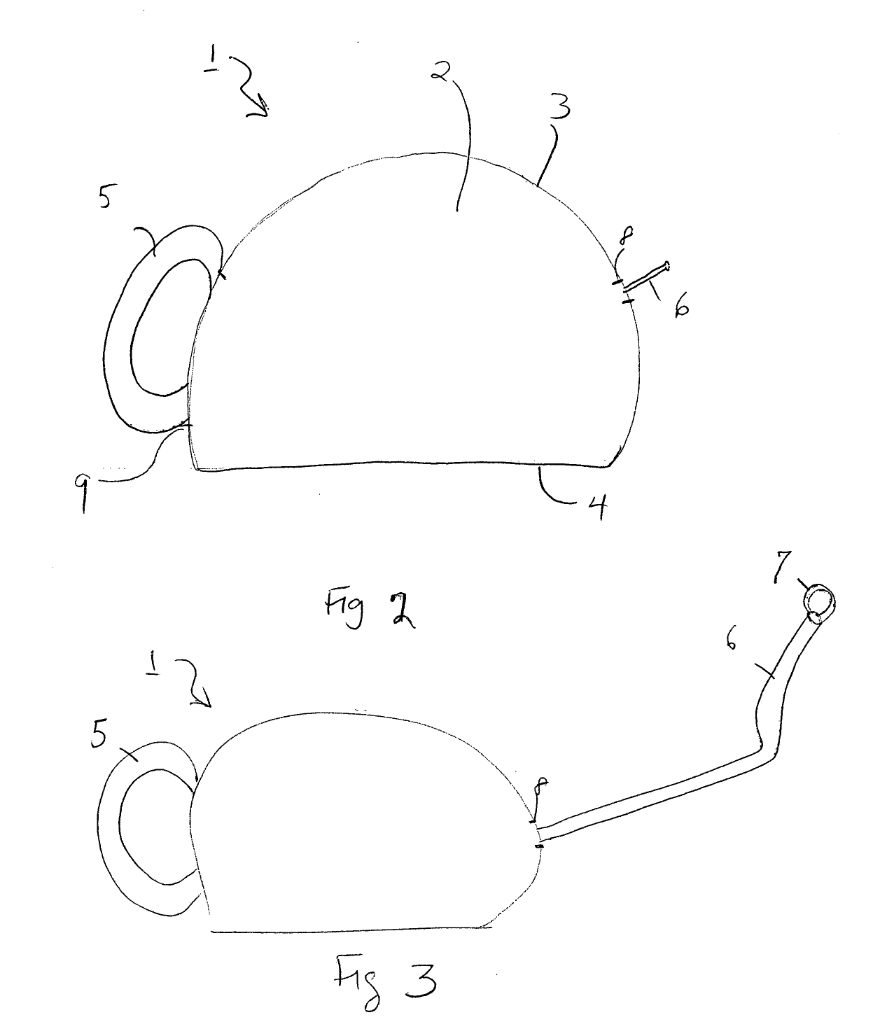

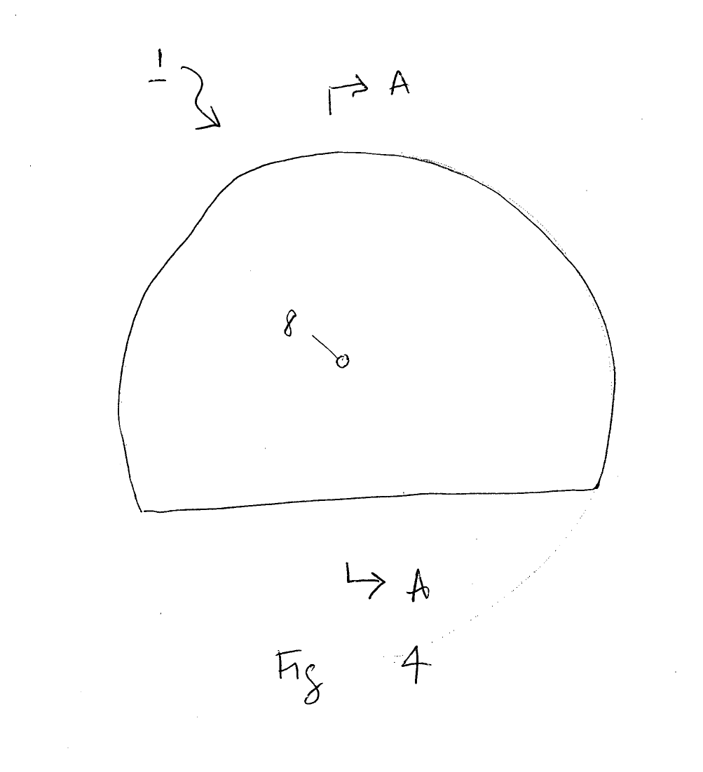

The restraint system 1 also includes a retracting mechanism 10 that governs the movement of the leash 6 inside and outside the body 2. As shown in FIG. 2, the leash 6 may be retracted to a position inside the body 2. As shown in FIG. 3, the leash 6 may be extended to a position outside of the body 2.

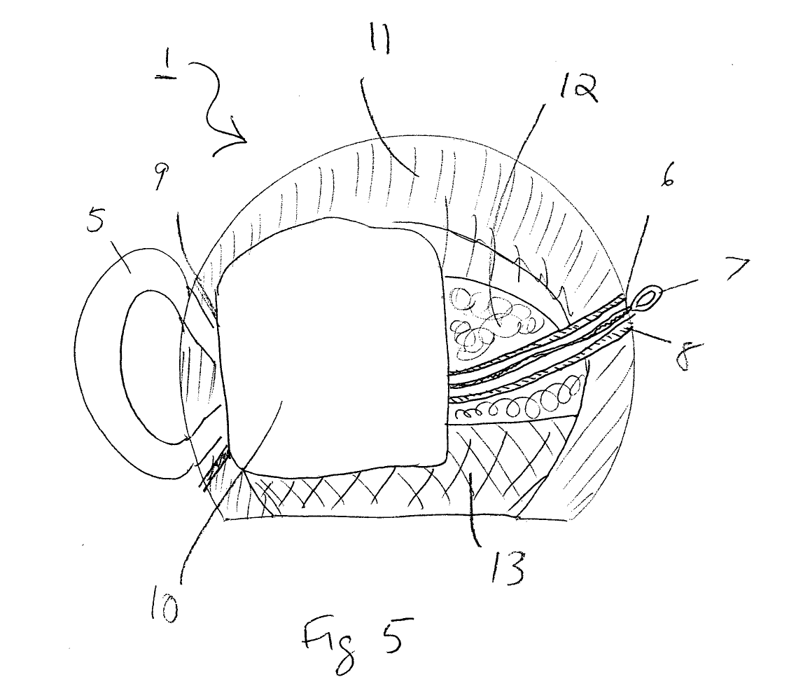

FIG. 5 depicts a cross sectional view of the pet restraint system 1 taken along line A-A of FIG. 4. As shown in FIG. 5, the body 2 of the pet restraint system 1 is a generally solid body formed of foam 11 and including a central cavity. The central cavity of the body 2 houses the retractable mechanism 10 and the ballast 13. The central cavity of the body 2 may also house material 12 filling the interstitial spaces of the cavity. The space filling material 12 may include any suitable composition such as, for example, expandable foam. The ballast may be constructed of any suitable material such as, for example, ankle weights.

The following is a description of a manner of constructing the pet restraint system 1 of the present invention. Initially, a solid body ball is obtained. The ball may be of any suitable material such as, for example, foam or Styrofoam. The foam may be spongy or soft (like a Nerf ball) or may be rigid. The ball is cut and a portion is removed so that a dome shape with a flat portion is provided. A portion of the foam material of the interior of the ball is then removed, through the flat portion. The foam 11 shown in FIG. 5 is the foam material that is left and remains in the ball. The foam 11 will be positioned at the top of the completed pet restraint system 1. The ball is hollowed out such that foam is left in the dome portion of the ball to produce a body 2 that is lighter in weight on the top. The retractable mechanism 10, including the handle 5 and the leash 6, is then inserted in the cavity left by the removal of the foam. The handle 5 extends through the aperture 9 and the leash 6 extends through the guide tube 8. The handle 5 may include a locking mechanism. The guide tube 8 may be positioned so that the leash 6 exits the dome near or slightly above the widest area of the dome. After positioning the retractable mechanism, the ballast 13 is inserted in the cavity. The ballast may be any suitable material such as, for example, weighted packets of iron ore or ankle weights, water, sand, or slug weight. Additionally, the weight of ballast may be determined by the size of the pet. Therefore, more or heavier ballast will be used for a large, heavy pet, and less or lighter ballast will be used for a small, lightweight pet. The remaining interstitial spaces of the cavity may then be filled with filling material 12. The filling material 12 may include any suitable material which will fill the remaining interstitial spaces, and in the present embodiment includes expandable foam. The expandable foam will be sprayed into the cavity, and will then expand to fill the interstitial spaces. Accordingly, all elements inside the cavity of the body 2 will be held stationary, producing a stable pet restraint system. Finally, the hole in the body 2 is covered to provide a closed body 2. The hole may be closed with a covering material, such as tape or cloth tape. A cloth tape will provide a soft feel and appearance to the body 2 of the pet restraint system 1. The covered hole becomes the bottom of the body 2, which will rest on the ground surface during use of the pet restraint system 1. Additionally, the tape provided on the bottom of the body 2 will provide a high friction surface to the body 2, which will decrease sliding of the body 2 across the ground surface during use of the system. The dome shape portion becomes the top of the body 2, and will be exposed and projecting upward during use of the pet restraint system 1. Accordingly, as shown in FIG. 5, the ballast 13 is positioned substantially at the bottom of the body 2 and the largest portion of the lighter weight foam material of the body 2 is positioned at the top of the body 2. Therefore, the body 2 has a low center of gravity or center of mass and the pet restraint system 1 will right itself.

Alternatively, the pet restraint system 1 of the present invention may be constructed in other ways. For example, the body 2 may be molded in its final shape to include a cavity and a flat bottom portion.

Although the invention has been described with reference to an exemplary embodiment, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed. Rather, the invention extends to all functionally equivalent structures, methods, and uses such as are within the scope of the appended claims.

What is claimed is:

1. A pet restraining device comprising:
a housing having a top portion, a bottom portion, and a cavity therein;
a retractable leash mechanism provided in said housing cavity; and
ballast provided in said housing cavity, said ballast being positioned in said bottom portion of said housing such that said pet restraining device has a center of gravity that is nearer to the bottom portion of said housing than to said top portion of said housing.

2. The pet restraining device according to claim 1, further comprising:
filling material provided in said cavity, said filling material securing said retractable leash mechanism and said ballast inside said cavity.

3. The pet restraining device according to claim 1, further comprising:
an aperture provided in said top portion of said housing;
a leash provided in said retractable leash mechanism; and
a guide tube provided in said aperture, said guide tube being configured to receive said leash therein such that said leash extends and retracts through said guide tube to project from said housing.

4. The pet restraining device according to claim 1, further comprising:
an aperture provided in said top portion of said housing; and
a handle provided on said retractable leash mechanism, said aperture being configured to receive said handle therein such that said handle projects from said housing.

5. A pet restraining device comprising:
a housing having a dome shaped top portion and a flat bottom portion;
a leash mechanism provided in said housing; and
ballast provided in said housing, said ballast being positioned near said flat bottom portion of said housing such that said pet restraining device has a low center of gravity.

6. The pet restraining device according to claim 5, wherein said ballast comprises one of sand, iron ore, and water.

7. The pet restraining device according to claim 5, further comprising:
filling material provided in said housing, said filling material securing said retractable leash mechanism and said ballast inside said housing.

8. The pet restraining device according to claim 7, wherein said filling material comprises expandable foam.

9. The pet restraining device according to claim 5, wherein said housing is constructed of foam material.

10. The pet restraining device according to claim 5, wherein said flat bottom portion comprises a base of said housing, further comprising:
tape provided on said base of said housing.

11. The pet restraining device according to claim 5, further comprising:
an aperture provided in said dome shaped top portion of said housing;
a leash provided in said leash mechanism; and
a guide tube provided in said aperture, said guide tube being configured to receive said leash therein such that said leash extends and retracts through said guide tube to project from said housing.

12. The pet restraining device according to claim 5, further comprising:
an aperture provided in said dome shaped top portion of said housing; and a handle provided on said leash mechanism, said aperture being configured to receive said handle therein such that said handle projects from said housing.

13. The pet restraining device according to claim 5, wherein said leash mechanism comprises a retractable leash mechanism.

14. A method of making a pet restraining device comprising:
providing a housing having a top portion and a bottom portion;
forming a cavity in said housing;
providing a leash mechanism in said housing cavity; and
providing ballast in said housing cavity, said ballast being positioned in said bottom portion of said housing such that said pet restraining device has a center of gravity that is nearer to the bottom portion of said housing than to said top portion of said housing.

15. The method of making a pet restraining device according to claim 14, further comprising:
providing filling material in said cavity, said filling material securing said leash mechanism and said ballast inside said cavity.

16. The method of making a pet restraining device according to claim 14, further comprising:
providing an aperture in said top portion of said housing;
providing a leash in said leash mechanism; and
providing a guide tube in said aperture, said guide tube being configured to receive said leash therein such that said leash extends and retracts through said guide tube to project from said housing.

17. The method of making a pet restraining device according to claim 14, further comprising:
providing an aperture in said top portion of said housing; and
providing a handle on said leash mechanism, said aperture being configured to receive said handle therein such that said handle projects from said housing.

18. The method of making a pet restraining device according to claim 14, wherein said providing a housing comprises:
providing a solid body ball;
removing a portion of said ball, to provide a dome shaped top portion and a flat bottom portion; and
said providing a cavity in said housing including removing an interior portion of said solid body ball.

19. The method of making a pet restraining device according to claim 15, wherein said providing filling material comprises filling said cavity with expandable foam.

20. The method of making a pet restraining device according to claim 18, wherein said flat bottom portion comprises a base of said housing, further comprising:
providing tape on said base of said housing.
